(19) United States
(12) Patent Application Publication
(10) Pub. No.: US 2009/0319306 A1
(43) Pub. Date: Dec. 24, 2009

(54) SYSTEM AND METHOD FOR VENUE ATTENDANCE MANAGEMENT

(76) Inventor: Richard A. CHANICK, Phoenix, AZ (US)

Correspondence Address: MCGUIREWOODS, LLP, 1750 TYSONS BLVD, SUITE 1800, MCLEAN, VA, 22102, US

(21) Appl. No.: 12/486,417

(22) Filed: Jun. 17, 2009

Related U.S. Application Data
(60) Provisional application No. 61/073,643, filed on Jun. 18, 2008.

(51) Int. Cl. G06Q 10/00; G06Q 50/00; G06Q 20/00; G06Q 30/00; G01C 21/00

(52) U.S. Cl. 705/5; 705/26; 701/207

(57) ABSTRACT

A system and method for managing attendance at a venue such as a fair, theme park, state park, and the like, is generally disclosed. The venue may having a plurality of different attractions managed at least in part by a computerized operational venue management system that interacts with one or more patrons having a mobile communications device (e.g., cell phone, PDA, Blackberry®, and the like). The patron may receive show information, for example, and remotely select options including ticket purchases for a show or attraction. Payment may also be authorized remotely, and an electronic ticket(s) may be provided. Moreover, real-time updates may be sent to the mobile communications device to provide ongoing information about the attractions such as show times, available tickets remaining, time to navigate to an attraction, and so forth.

### CROSS-REFERENCE TO RELATED APPLICATIONS

This application claims benefit and priority to U.S. Provisional Application No. 61/073,643 filed Jun. 18, 2008 and entitled SYSTEM AND METHOD FOR VENUE ATTENDANCE MANAGEMENT, the disclosure of which is incorporated by reference herein, in its entirety.

### BACKGROUND OF THE INVENTION

1.0 Field of the Invention

The present invention is generally related to global positioning systems, and more particularly, to integrating customer positional information within a venue with additional features specific to the venue, including purchases by a mobile patron of the venue.

2.0 Related Art

In general, when a customer attends an entertainment or recreational venue (e.g., amusement park, sporting event, museum, fair, or festival), the location of attractions within the venue may be disclosed to visitors via leaflets or paper maps. While these maps may provide general directions to various attractions, they are often limited in the amount of information provided due to space limitations. Furthermore, if any information changes, old maps are often discarded, then new maps need to be reprinted and distributed. To minimize the frequency of changes, many venues often keep the information generic, without specific attraction information, such as show times or visiting performers.

Once at a venue, visitors spend a large amount of time understanding the venue and attempting to determine the optimum path to see desired attractions, performers, and/or to determine best times to seek out performances. Visitors often consider other factors when determining the optimum path such as, for example, comparing start times for attractions, length of time to stand in lines, and researching where and what to eat. Planning and revising the path or daily plan is often considered wasted time that could be better spent enjoying the venue. Because a customer's time is limited, this wasted time takes away from opportunities where the customer can spend money on attractions, food, gifts, and the like. To further assist in navigation, venues spend a considerable amount of money placing signposts across the venue alerting customers to pathways, restrooms, attractions, eating establishments, and the like.

Position determining systems, such as Global Positioning Systems (GPS), have been used to provide location maps for a variety of purposes such as finding camping areas, fishing areas, paths, mountains and other waypoints. Many systems employ handheld units embodying these position determining systems to aid in navigation. Using such systems, people would be able to determine their location with respect to various attractions and points of interest within a venue. With some handheld units, customers are able to set waypoints (i.e., signposts of their own) so that the unit may plot a route to the next way point. Some units may also provide a tracking function which periodically records the location and activity of a particular device. However, the functionality is often limited to the map loaded in the unit.

Destination venues, such as amusements parks, where families may attend once in their lifetime, have a direct interest in providing the best experience possible to its customers. Most venues are constantly trying to improve the customer experience and encourage the customer to utilize more of the goods and services. For example, after plotting a path to an attraction, customers may become disappointed when they discover that, once they arrive at the attraction, they must stand in line for extended periods of time. Moreover, customers' plans which are completed at the beginning of the day often get altered because certain group members deviate from the plan. If a customer is not able to enjoy a full experience in different parts of a venue, the venue owner usually foregoes precious experiential and financial opportunities.

A need exists for a system and method which captures and organizes customer needs at a particular location and at a particular time in an effort to offer appropriate or desired value-added services. A need also exists for a system and method that can integrate a customer's location with venue-specific information when and where it is needed by the customer.

### SUMMARY OF THE INVENTION

The invention meets the foregoing need and overcomes the limitations in the prior art by providing an interactive type of communication to patrons within a venue like a theme park, state or federal park, fair, convention and the like. While the way in which the present invention address the disadvantages of the prior art will be discussed in greater detail below, in general, the present invention provides for systems and methods for integrating user positional information with venue information.

In one aspect, a method of integrating user positional and venue information includes the steps of determining the positional information related to an item in a venue via the environment interface system, transmitting the positional information to a feature set system through a network environment, promising the positional information with venue information in order to produce a venue-specific result, and outputting the venue-specific result through the network environment to the user interface system.

In another aspect, the positional and venue information system includes an environment interface system, a feature set system, a user interface system, and a network providing two-way communication between these systems. The environment interface system may utilize a GPS satellite signal or a network of RFID transceivers, antennae, transponders, or tags. The feature set system may include venue-specific results such as language options, mapping, routing, task list, weather, distress alerts, advertising, transactions, point of interest information, or personal communication. In one aspect, user input to the system and output by the system is conducted through a personal point of interaction device.

In one aspect, a method for managing attendance at a venue, the venue having a plurality of different attractions managed at least in part by a computerized operational venue management system, is provided. The method may include receiving at a mobile communications device from the computerized operational venue management system information related to at least one attraction within the venue, the venue having pre-defined boundaries, the mobile device associated with a patron of the venue, responding to the information to indicate an intent to purchase at least one entrance pass to at least one attraction, and receiving a receipt at the mobile communications device.

In still another aspect, a system is provided for managing attendance at a venue, the venue having a plurality of different attractions. The system includes an operational venue management system that manages at least in part the plurality of different attractions, the operational venue management system includes a first component to transmit information related to at least one attraction within the venue to at least one mobile communications device associated with a patron, the venue having pre-defined boundaries, a second component to receive information that indicates an intent to purchase at least one entrance pass to at least one attraction, and third component to communicate a receipt to the mobile communications device.

In another aspect, a system for managing attendance at a venue, the venue having a plurality of different attractions, the system includes an operational venue management system that manages at least in part the plurality of different attractions, the operational venue management system including a first component to transmit information related to at least one attraction within the venue to at least one mobile communications device configured to be carried by a patron of the venue, the venue having pre-defined boundaries maintained in a database readable by the operational venue management system, a second component to receive information that indicates an intent to make a purchase associated with at least one attraction pre-defined as part of the venue and a third component to communicate a receipt to the mobile communications device.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

These and other features, aspects, and advantages of the invention may best be understood by reference to the following description taken in conjunction with the accompanying drawings in which like numerals represent like elements:

FIG. 1 illustrates an exemplary customer positional and venue information system according to an embodiment of the invention;

FIG. 1A is an illustration representing different types of venues, according to principles of the invention;

FIG. 1B is a block diagram of an embodiment of an environmental interface system, configured according to principles of the invention;

FIG. 1C is a block diagram showing exemplary types of items that may be associated with a venue, and also in which a user interface may be used, according to principles of the invention;

FIG. 2 illustrates a map and routing feature according to an embodiment of the invention;

FIG. 3 illustrates a transactions feature according to an embodiment of the invention;

FIG. 4 is a flow diagram showing exemplary steps performed according to principles of the invention;

FIG. 5A is an illustration of various exemplary types of venue information that may be processed by embodiments of the invention;

FIG. 5B is an illustration of exemplary types of venue-specific results output by embodiments of the invention;

FIG. 6 is a flow diagram showing various functions performed by various embodiments of the invention;

FIG. 7 is a flow diagram showing steps of an exemplary process performed according to principles of the invention; and

FIG. 8 is a flow diagram of an exemplary process performed according to principles of the invention.

### DETAILED DESCRIPTION OF THE INVENTION

It is understood that the invention is not limited to the particular methodology, protocols, etc., described herein, as these may vary as the skilled artisan will recognize. It is also to be understood that the terminology used herein is used for the purpose of describing particular embodiments, and is not intended to limit the scope of the invention. It is also to be noted that as used herein and in the appended claims, the singular forms “a,” “an,” and “the” include the plural reference unless the context clearly dictates otherwise. Thus, for example, a reference to “an address” is a reference to one or more addresses and equivalents thereof known to those skilled in the art.

Unless defined otherwise, all technical and scientific terms used herein have the same meanings as commonly understood by one of ordinary skill in the art to which the invention pertains. The embodiments of the invention and the various features, aspects, and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

It should also be noted that the software implementations of the invention as described herein may be stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein may be stored.

The present invention facilitates the enjoyment of recreational and entertainment venues while providing safety, convenience, and multi party features. The invention has similar application to various other venues or locations, such as educational institutions and/or the workplace.

In general, the invention provides a system and method for facilitating positional, transactional, and other user interactive features through communication devices. In particular, the system and method facilitates determination of the relative position of users within a venue by communicating with an environmental interface system. The invention also provides, in part based on this information, user interactive features related to points of interest at a venue occurring in association with a point of interaction (POI) device. Various types of POI devices and/or static devices may be used to connect to one or more communication networks. For example, the Global Positioning System (GPS) is one such network which is readily accessible by a wide variety of POI devices and thus, the following examples will often be described in this context. The system comprises one or more environment interface systems in communication with the POI to provide positional information. Additionally, the system may comprise optional transactional and/or user interactive systems for providing additional features such as, for example, payment processing, routing, advertising, mapping, safety (e.g., distress calls, amber alerts), ticketing, and the like.

Thus, as will become apparent from the following descriptions, the system and methods of the invention facilitate determining one or more positions within a venue, interacting with or between one or more users, and/or performing one or more transactions in a wide variety of applications.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The invention may be described herein in terms of functional block component, optional selections and various processing steps. It should be appreciated that such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices.

Similarly, the software elements of the invention may be implemented with any programming, scripting language or web service protocols such as C, C++, Macromedia Cold Fusion, Microsoft Active Server Pages, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the invention may employ any number of conventional techniques for data transmission, signaling, data processing, network control, and the like, e.g., TCP/IP, IPX, Appletalk, IP-v6, NetBIOS, OSI or any number of existing or future protocols. For additional information on communication systems, network programming, web services, and security, refer to Gilber Held, “Understanding Data Communications,” (1996); Dilip Nail:, “Internet Standards and Protocols,” (1998); and Java 2 Complete, various authors (Sybex 1999); the Object Management Group website at http://omg.org; the Sun Microsystems Java web site at http://www.suri.java.com; the Universal Description, Discovery, and Integration Organization at http://www.uddi.org; and “Cryptography & Network Security: Principles & Practice” by William Stalling, published by Prentice Hall; all of which are incorporated by reference.

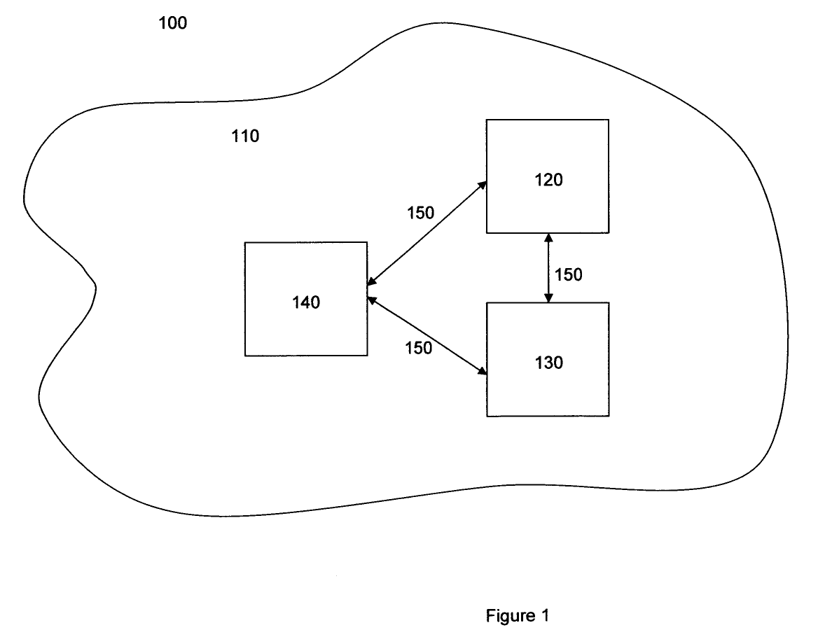

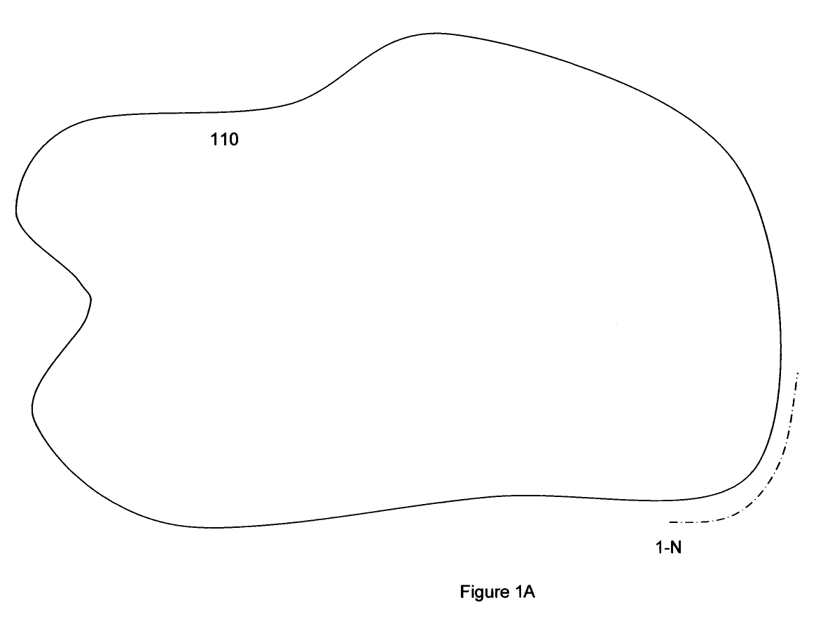

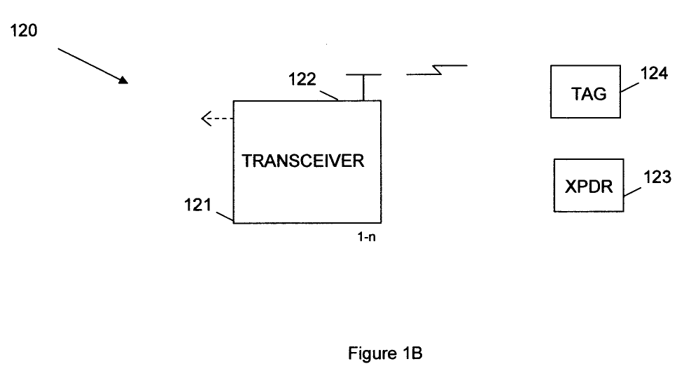

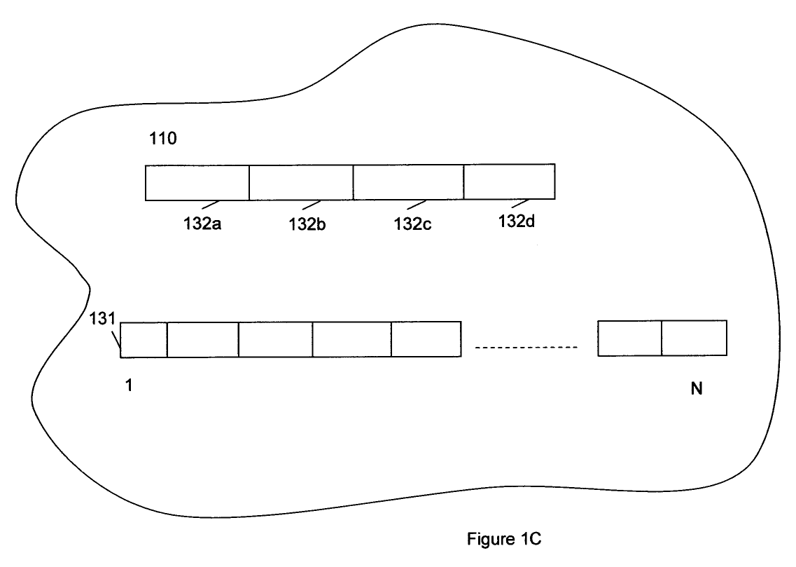

FIG. 1 illustrates, in block format, an exemplary user positional and venue information system 100 of the invention. In one aspect, a user positional and venue information system comprises a venue 110, an environment interface system (EIS) 120, a feature set system (FSS) 130, and a user interface system (UIS) 140. These systems communicate over one or more networks 150, using protocols suited to the particular system and communication.

As used herein, the term “user” shall include any person (e.g., customers, tourists, purchasers, buyers, conference attendees) business, and hardware and/or software application which access the system through the UIS 140.

As used herein, the term “network’ shall include any electronic communications means which incorporates both hardware and software components of such. Communication among the systems may be accomplished through any suitable communication channels, such as, for example, a telephone network, an extranet, an intranet, Internet, point of interaction device (point of sale device, personal digital assistant (e.g., Palm Pilot®, Blackberry®), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, the system may also be implemented using TCP/IP, IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

The various system components may be independently, separately or collectively suitably coupled to network 150 via data links which includes, for example, a connection to an Internet Service Provider (ISP) over the local loop as is typically used in connection with standard modem communication, cable modem, Dish networks, ISDN, Digital Subscriber Line (DSL), or various wireless communication methods (see, e.g., Gilbert Held, Understanding Data Communications (1996), which is hereby incorporated by reference). It is noted that network 150 may be implemented as other types of networks, such as an interactive television (ITV) network. Moreover, the system contemplates the use, sale or distribution of any goods, services or information over any network having similar functionality described herein.

As used herein, “transmit” may include sending electronic data from one system component to another over a network connection. Additionally, as used herein, “data” or “information” may include encompassing information such as commands, queries, files, data for storage, and the like in digital or any other form.

POI devices may embody all or portions of any of the functions and structures of the invention. In one aspect, a POI device may comprise a modified GPS unit. This unit may comprise a receiver for a GPS signal, a portion of EIS 120, and a display screen, a portion of UIS 140. POI devices may comprise point of sale devices, for example, cash registers, personal digital assistants (e.g., Palm Pilot®, Blackberry®), cellular phones, kiosks, LCD display panels, TV screens, and the like. As used herein, “personal POI devices” (PPOI) are defined as any POI device capable of being carried by a person either in the hand or attached to items personal to a user such as clothing, a stroller, a backpack, and the like.

Venue 110 may include any location, or set of locations, where a user may wish to spend leisure, work, adventure, and/or educational time. Venue 110 is not limited by physical location, but includes the various business relationships that assist in defining a customer's experience associated with a location, event, destination and the like. For example, venue 110 may include amusement parks, museums, natural attractions (such as the Grand Canyon or national parks), ski areas, convention centers, hotels, retail and other shopping establishments, wholesale markets, grocery stores, sports stadiums, fields, or playing areas, educational institutions, tour buses, zoos and the like; these multiple types of venues are shown illustratively in relation to FIG. 1A, the multiple types of venues being designated by 1-N. In some aspects, a venue may include two or more locations where the venue owners cooperate with each other to provide shared experiences or ticketing arrangements.

In one aspect, a venue may be pre-defined to include one or more hotels and the area surrounding these hotels. Hotels may sponsor the purchase and/or rental of PPOI devices to their guests. Businesses surrounding the hotel would pay the hotel to advertise on the PPOI device or through the systems and methods of the invention. In another aspect, a venue may be pre-defined to include hotel chains selling advertising opportunities to restaurants or other businesses that regularly locate near a particular hotel chain. For example, a fast food chain's business model may be to always locate near a particular brand of hotel. Knowing this, the hotel chain can offer advertising sponsorships to the fast food chain on a regional, nationwide, or worldwide basis.

In another aspect, a venue may be pre-defined to include a convention center and the surrounding areas and businesses in the city. For example, the convention center owner, or the convention and visitor bureau, may sponsor PPOI devices and provide them to convention guests (e.g., rented, sold, given away). Because the city and local merchants have a vested interest in keeping the convention guests in the area, the local merchants can provide advertising, coupons, and the like on or through the PPOI device.

In yet another aspect, a venue may include a location such as a football stadium and the surrounding area, also included as a type of venue in the illustration of FIG. 1A. For example, the local chamber of commerce may provide PPOI devices to persons connected with an event at the stadium (e.g., a football game). In order to incent people to stay in the local area, the chamber may provide advertising opportunities, or sponsorships, to businesses in the local area. These advertisements are transmitted to people throughout the venue on or through the PPOI devices.

In another aspect, venue may be predefined to include an educational institution, campus, or other education based location and the surrounding areas. For example, a college may provide a PPOI device to parents and/or students. Various college departments (e.g., the athletic department) may provide information such as advertising on or through the PPOI device for local area businesses that support the athletic teams of the college. Other information especially germane to this venue may be safety information such as closest police station or medical facility. This information may be maintained in a system database for use during processing of events associated within the pre-defined venue.

In another aspect, a venue may be defined to include tourist destinations such as, for example, the Air Force Academy, included as a type of venue in FIG. 1A. Tourists may rent PPOI devices to access information on the device about the history, construction, and the like as they move from attraction to attraction within the boundaries of the tourist destinations. In this example, the limits of the geography may be pre-defined and any associated businesses or attractions may be pre-defined and maintained in a system database for conveying information to visitors within or related to the venue.

Another aspect of a venue may be the Olympics (included as a type of venue in FIG. 1A) which may comprise multiple dispersed but affiliated geographic locations to pre-define an overall venue. These locations and boundaries may be pre-defined (perhaps by GPS specifications or other geographic type specifications) and maintained in a system database for recall and use. Yet another example may be Disneyland® owned properties in a particular region of the country. Venue 110 may also include electronic venues or virtual reality venues such as, for example, adventure games over the internet. In these examples, a venue may be pre-defined by specific parameters to specify the venue boundaries and/or specify the associated affiliations. In some applications these venue boundaries may include virtual and/or actual pre-defined associations. These pre-defined parameters may permit geographical specification such as GPS boundaries to be applied. The boundaries may be fixed. In some applications, the boundaries may be updated as changes to the venue boundaries change (such as new physical additions to a park, for example); but at any given moment of access or use, the boundaries are known and defined and the operational features of the system and method may be bound by these boundaries and/or pre-defined associations. For example, a theme park would have specific geographic boundaries pre-defined that are stored in an associated database for recall.

Environment interface system (EIS) 120 includes any hardware and/or software suitably configured as a positioning network that determines location in two dimensions, optionally three dimensions, of an item as may be needed for a particular application of the invention. As used herein “item” is defined as a POI device, a person, and an attraction, a point of interest, or any other physical location or thing within venue 110. In aspects, EIS 120 includes one or more networks communicating via wireless or wired protocols. For example, EIS 120 may include any known or discovered technique for determining position, such as radiolocation, multi-alteration, or tri-alteration. In one aspect, EIS 120 includes a global positioning system. The GPS is a well known system used for location determining applications and therefore will not be described in detail. In another aspect, a PPOI device utilizing the GPS is sold by Magellan® available at www.magellangps.com as the Road Mate 300 North America. In another aspect, EIS 120 is a network of radio frequency identification (RFID) transceivers 121, antennae 122 and transponders 123. For example, systems embodying an RFID network are sold by Symbol® available at www.symbol.com as the RFID Kit. As with the UPS, operation of RFID as a location determining network is known and will not be described in detail. In various aspects, EIS 120 may comprise telephone networks (land or wireless), Internet, intranet, extranet, WAN, LAN, satellite communications, wireless radio networks, or any network capable of transmitting and receiving electromagnetic signals and the like. In aspects, it should be appreciated that, although not shown or described, additional connections, links and/or adapter interfaces may occur between components of the system such as connections to a wireless base station, web translation server, router, and/or a coordinator system to drive routing within the system. In this manner, EIS 120 may include multiple networks capable of two-way communication between these networks. Furthermore, the details of determining position using the above techniques are well-known, and thus, will not be described in detail. FIG. 1C illustrates that the PPOI device may be associated with a person, point of interest, ride, attraction, room, product, store, restaurant, ticket, pass, restroom, emergency area, software and hardware, each of which are included in the illustrative list denoted by 1-N.

Feature set system (FSS) 130 may include any suitable software and/or hardware suitably configured to provide functionality and user interactivity as may be needed for a particular application of the invention in a particular venue. In general, FSS 130 is implemented as a combination of databases, servers, fixed and mobile devices, and application software that are configured so that the feature set system communicates with ES 120 and UIS 140. In various aspects, some applications of the FSS 130 are configured to operate a POI device within the venue. Other applications within the feature set system are configured to enable the functionality between POI devices, EIS 120, and venue 110 and may be delivered through various networks, programming languages, hardware and software as described above.

In one aspect, FSS 130 includes a multiple language platform. FSS 130 is used to provide real-time language translation of information communicated to FSS 130 by other components of the system. For example, the invention provides the user with the capability to select a particular language such as Japanese. In one aspect, a PPOI device comprises a physical or electronic selection button which toggles the languages available within a particular venue. In another aspect, FSS 130 provides language translation, wherein the user is able to type in words or phrases and FSS 130 translates the entries into the selected language.

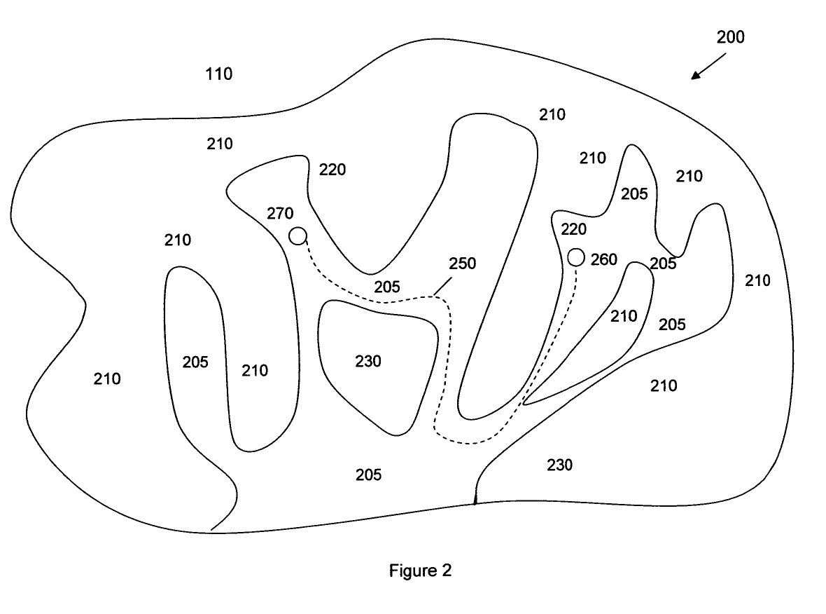

In another aspect, FSS 130 includes generating maps and routes within a particular venue. The system provides the user with a pictorial or text display of venue 110, indicates multiple points of interest within venue 110, and relates points of interest to other points within venue 110 in various ways. The type of mapping information included within the system for display by UIS 140 may be of any variety suited to a particular application of the invention, for example, a topographical or a topological map. The resolution of the map and details provided may vary depending on the particular need. As such, any type of map now known or hereafter discovered that shows position and reveals location details within a venue may be suitable to use with this invention. For example, in one aspect, a map may reveal the location of all the major attractions in a theme park. In other aspects of the invention, multiple maps are provided depending on the particular “view” of the venue the user selects. For example, a user may wish to only view the location of restrooms or emergency areas within a venue and would select the appropriate map to be displayed. At a different time during the visit, the user may wish to view a map which only displays the location of eating establishments. FIG. 2 illustrates an exemplary embodiment of a map 200 of a venue 110 revealing walking paths 205, major attractions 210, restrooms 220, and restaurants 230, according to principles of the invention.

Furthermore, by analyzing information received from EIS 120, the user may be provided with distance and routing information. For example, in various aspects, location data may be obtained from EIS 120. This information may be transmitted to FSS 130 and integrated with known venue specific locations and features thereof. FSS 130 calculates and compares a variety of distances between points. Depending on the application and/or user choice, the system provides routing information. In one aspect and with reference to FIG. 2, the system calculates the best route 250 to a particular point 260 within venue 110 from the user's current location 270 and provides the results to UIS 140. In another aspect, the system calculates the closest points of interest within a venue and displays the results through UIS 140. In yet another aspect, the system uses topographical information to provide the user with an “easy” walk (i.e., a route with the lowest total gradient along a route, or with gradients no greater than a particular amount in any given route).

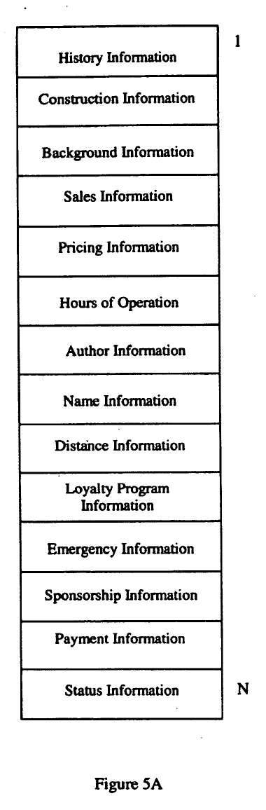

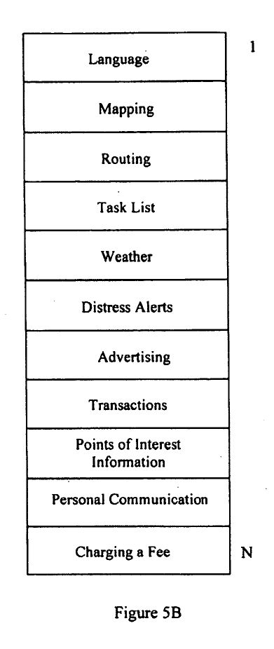

In various aspects where multiple people from a group utilize the system (e.g., families using PPOI devices), FSS 130 interacts with EIS 120 to provide mapping and routing information of the PPOI devices relative to each other. EIS 120 supplies the locations of each PPOI device, and consequently the location of a person, to FSS 130 which calculates and superimposes the relative positions and distances of everyone in the group on each person's map displayed through UIS 140 on the PPOI devices. In one aspect using a PPOI device, a user requests a display of the locations of all other people in a group, and then suggests the shortest route to another location for everyone in the group to meet. Although mapping and routing are described herein by way of a few examples, any configuration of mapping and routing information within a venue is contemplated by this invention. As shown in relation to FIG. 5B, a venue-specific result may include at least one of a language, mapping, routing, task list, weather, distress alerts, advertising, transactions, point of interest information, and personal communication. As shown in relation to FIG. 1C, a user interface may include an interface for use by a person 132a, a business 132b, a hardware application 132c and a software application 132d.

In another aspect, FSS 130 includes a task list 131. The task list provides a user with the ability to keep track of activities in relation to points of interest visited within venue 110. In various aspects, FSS 130 tracks where the user has been within a venue 110 and automatically “checks off” each location visited. The user may be able to know which locations they have seen, and which locations remain to be seen within venue 110. For example, in one aspect, a user in a theme park may have all of the theme park's rides indicated on the task list in a PPOI device. As the user visits each ride, the ride may be designated as visited and “checked off” the task list. In one aspect, FSS 130 compares the locations on the task list with the locations the PPOI device has been as communicated by EIS 120. Once two locations match, the ride may be designated as completed. The designation may exist in the database, but it may also be displayed to the user via a flag, change of color, noise or other indicia or signal. Alternately, the user can manually check off the location by input through UIS 140. As a result, the user can always be aware of which rides they need to visit before the end of the day. In another aspect, a participant at a convention may select a number of vendors (the list may contain all the vendors, or a sub-set) that must be visited during the trip. As the user visits each vendor's location within the convention, the visited locations are “checked off,” or otherwise designated as visited, from the list.

Any of the features discussed herein may also incorporate a loyalty point or other incentive system. An existing incentive system may be incorporated, or the system may include its own incentive system. For example, the system may print a coupon or reward (or download points to an account) after the user visits a certain number of locations.

In one aspect, a convention and visitor's bureau may provide PPOI devices to conventioneers. By EIS 120 communicating with FSS 130, the convention bureau may provide loyalty points for staying in the local area, visiting local businesses, and purchasing goods and services. These loyalty points may be redeemable for additional goods and services in the area, discounts, coupons for future events, and the like.

In another aspect of FSS 130, the invention incorporates weather reports and associated information. This has particular beneficial use in outdoor venues such as amusement park, skiing, hiking, or golf venues. For example, in one aspect, a skier utilizing the system and methods may be alerted to severe weather approaching the location, so the system may adjust the map or schedule to complete the outdoor activities earlier before, for example, severe snow fall starts. In another aspect, for venues that span multiple days, an extended weather forecast may be provided so that visits to attractions within the venue may be planned accordingly.

In another aspect of FSS 130, the system provides distress alerts. The form of alert provided may be configured to the particular application. For example, in various aspects utilizing PPOI devices, an alert may be delivered from FSS 130 to UIS 140 via a text message. In another aspect, the alert takes the form of a blinking light. In yet another aspect, the alert may be an audible signal. In other aspects, the alert comprises a picture of a location or a person. Distress alerts may be of several types such as medical alerts, panic alerts, amber alerts, and the like. For example, if a user may be lost within a venue, a distress alert may be activated which notifies a central monitoring location or other device. The distress alert may send location and/or description information, and a picture of the user to the central monitoring location so that the user may be found. In another aspect, a PPOI device may notify a central monitoring system when it travels “out of bounds.” For example, areas at a ski resort are typically designated off limits to particular skiers. If a skier utilizing this system travels outside those limits, the system can notify the resort of the violation. Similarly, in another aspect, the system may be configured such that “out of bounds” may be defined based on skier ability. For instance, a skier rated as a novice should not attempt advanced “black diamond” trails. By communicating with EIS 120, FSS 130 can provide an alert that notifies the user that a particular trail may be outside the skier's ability. Similar warnings may be provided to parents when children enter undesirable areas or are near undesirable people. Any number, form, type of alerts can be devised using the system and methods of the invention depending on its particular application and is contemplated and intended to be within the spirit of the invention.

In another aspect of FSS 130, the invention includes advertising to a user of the system. Advertising may be triggered and delivered in a variety of ways throughout the system. For example, advertising or sponsorship can be placed on PPOI devices (e.g., a company logo), or delivered through the devices using the systems and methods of the invention. In various aspects, advertising may be delivered to the user of the system based on the user's position with venue 110. For example, as a user walks by a restaurant within venue 110, EIS 120 communicates location information to FSS 130. FSS 130 compares this location to the restaurant's location. If the locations match (within a certain degree, which may be set as desired), or are within designated distance parameters, the system initiates an advertising message to the user through UIS 140. If the user may be utilizing a PPOI device, the message may be in the form of a text or auditory message. Alternatively, the restaurant may be equipped with another aspect of the invention which detects the proximity of the user and delivers an advertising message through a device controlled by the restaurant, for instance, a loud speaker or sign board.

In other aspects, advertising may be integrated with other aspects of FSS 130. For example, a customer may rent a PPOI device. At the end of the day, and upon return of the device, the customer may be presented with advertisements relating to the points of interest visited, or not visited.

In another aspect, FSS 130 facilitates processing or enhancing transactions occurring within a venue. The transactions contemplated by the system and methods of the invention may be of a financial or non-financial nature. For example, in various aspects, FSS 130 may be integrated with a payment processing system that charges an account based upon where a particular user has been within venue 110. In other aspects, FSS 130 allows access for one or more users to a particular venue or part of venue 110. For example, in one aspect, EIS 120 and FSS 130 are integrated with an amusement park's pass system. Rather than distributing paper tickets, a family of four may purchase a pass enabled with the systems and methods of the invention. Some amusement parks sell varying levels of access to their attractions. As the family of four visit attractions within the park, the enabled pass allows access to other events to the whole family based on position and information from the transactional system. In another aspect, many amusement parks are linked through special discounts or overlapping ownership. A pass enabled with the systems and methods of the invention may allow access to multiple amusement parks without the need to issue multiple tickets. In another aspect, ski areas may allow guests with a PPOI device shortcuts, or “fast pass”, in lift lines.

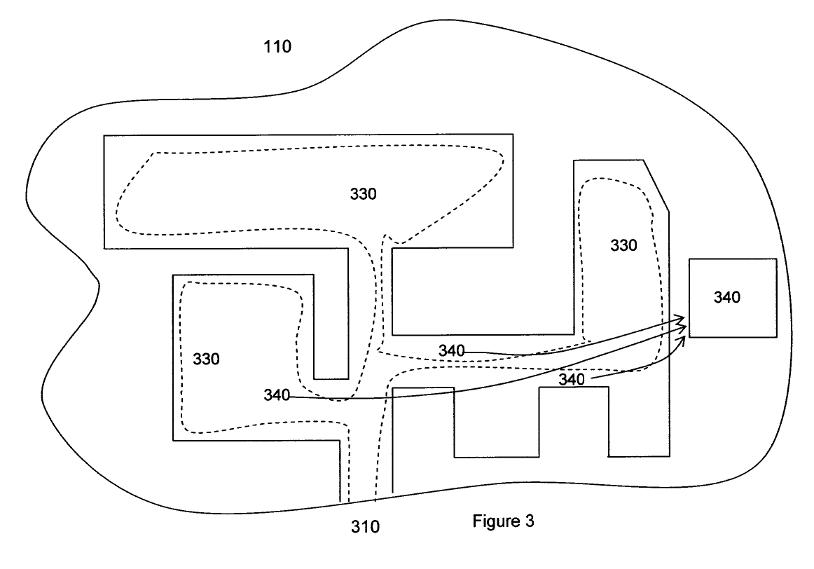

In another aspect, FSS 130 may be configured to debit or credit a linked account depending on the location of a customer. For example, and with reference to FIG. 3, people visiting a museum are oftentimes charged on the number of attractions, or sub-set of attractions they wish to visit. Using a pass embodying the systems and methods of the invention, the pass can be linked to a payment processing system 340. A customer may swipe a credit card at the entrance 310, pick up a pass, and roam the museum 320 without interference from a cashier or limited by “paper-ticket” boundaries. As the customer navigates a path through the museum 330, the pass keeps track of the locations visited and charges the credit card through the payment system 340. In an alternate example, a pass may be purchased with a number of credits associated with it. As the customer roams, EIS 120 provides information to FSS 130 as to the locations visited. FSS 130 can debit the pass as the customer passes by the attractions until the credits are used up. Once used, the pass may disable further access to points of interest within venue 110. As may be apparent, there are a number of credit, debit, and payment processing schemes available and any scheme that links this information with position determining features are intended to be within the spirit of the invention.

In another aspect, FSS 130 provides information about specific points of interest. In various aspects, information may be provided to the user about points of interest in which the user may be not located at or near. For example, in venues that involve waiting in a line (e.g., amusement parks, ski areas, sporting events), information such as expected ride time or expected wait time can be provided. In one aspect, EIS 120 provides FSS 130 a number of positional readings of a user in a line over a specified time period. Then, FSS 130 calculates an estimated wait time in line based on the time differences between the positional readings. FSS 130 communicates the wait time to UIS 140 for display.

In other aspects, the system provides information about points of interest in which the user may be located at or near. For example, in a museum utilizing the system and methods of the invention and as a user moves through the museum, EIS 120 provides position readings to FSS 130. When FSS 120 determines that a user may be near, for example, a work of art, FSS 130 provides UIS 140 information to display such as artist background, history of the work of art, or the like.

In one aspect, PPOI devices may be utilized to provide some or all of the features of the system. FSS 130 provides two-way communications between these PPOI devices. For example, two users may be able to send and receive text, pictorial, and/or voice messages between the PPOI devices. The details of providing voice, pictorial, and text messaging between two electronic devices is known and will not be described in detail. However, any two-way communication between users of the system using PPOI devices is contemplated and intended to be within the spirit of the invention.

User information system (UIS) 140 may include any suitable structure which allows a person to interact with EIS 120 and FSS 130. For example, UIS 140 may include an output and an input method. Output method includes any suitable structure now known or as yet unknown, which can transmit visual and/or audio signals to the user. In one aspect, the output method may be a display window on a PPOI device. In another aspect, display may include an LCD screen and mono speaker. In yet another aspect, the output method may be a display fixed at a point within a particular venue.

Input method may include any suitable structure, now known or as yet unknown, which enables a user to issue commands, instructions, submissions, procedures or other analog or digital inputs to UIS 140. For example, input method may include a keypad with keys representing numbers, functions, or some combination thereof. In another aspect, input method may include a touch screen. In this particular example, the touch screen may function as both the input and output method. In yet another aspect, input method may include a pen or voice recognition and activation.

An exemplary device embodying portions of the invention may be a PPOI device enabled with a GPS-enabled transceiver which typically connects to a GPS network. In another aspect, shown in relation to FIG. 1B, PPOI device may include one or more Radio Frequency Identification (RFID) transponders 123, antennas 122, tags 124, and/or transceivers which may interact with a network of RFID transceivers 121 situated within a particular venue. In addition, the PPOI device may also connect to a second communication network, for example, the Internet. Furthermore, the PPOI device may communicate with other PPOI devices through a network.

In various aspects, UIS 140 may include a web-compliant PPOI device suitably capable of processing web pages and multimedia information (i.e., text, graphics, video and/or audio), and may include a web-client software, an audio processor, a visual display, and/or an audio transducer. Web-compliant PPOI device may be of a type capable of establishing a packet communication link via the Internet using a common protocol, e.g., Hyper-Text Transfer Protocol (HTTP), the operation of which may be beyond the scope of this invention and will not be described in detail.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor, and a plurality of databases. Various databases used herein may include: client data; financial institution data; and/or like data useful in the operation of the system. As those skilled in the art will appreciate, devices may include an operating system (e.g., Windows NT, 95/98/2000, OS2, UNIX, Linux, Solaris, Maces, etc.) as well as various conventional support software and drivers typically associated with computers. The computer may include any suitable personal computer, network computer, workstation, minicomputer, mainframe or the like. User computer can be in a home or business environment with access to a network. In another aspect, access may be through a network or the Internet through a commercially-available web-browser software package.

The system contemplates uses in association with web services, utility computing, pervasive and individualized computing, security and identity solutions, autonomic computing, commodity computing, mobility and wireless solutions, open source, biometrics, grid computing and/or mesh computing.

Database may be any type of database, such as relational, hierarchical, object oriented, and/or the like. Common database products that may be used to implement the databases include DB2 by IBM (White Plains, N.Y.), any of the database products available from Oracle Corporation (Redwood Shores, Calif.), Microsoft Access by Microsoft Corporation (Redmond, Wash.), or any other database product. Database may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the manufacturer and retailer data tables. A “key field” partitions the database according to the high-level class of objects defined by the key field. For example, a certain class may be designated as a key field in both the first data table and the second data table, and the two data tables may then be merged on the basis of the class data in the key field. In this aspect, the data corresponding to the key field in each of the merged data tables may be preferably the same. However, data tables having similar, though not identical, data in the key fields may also be merged by using AGREP, for example.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the User are permitted to delete a data set. Various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the system may include any combination thereof at a single location or at multiple locations, wherein each database or system includes any of various suitable security features, such as firewalls, access codes, encryption, decryption, compression, decompression, and/or the like.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks.

Firewall may include any hardware and/or software suitably configured to protect components and/or enterprise computing resources from users of other networks. Further, a firewall may be configured to limit or restrict access to various systems and components behind the firewall for web clients connecting through a web server. Firewall may reside in varying configurations including Tasteful Inspection, Proxy based and Packet Filtering among others. Firewall may be integrated within a web server or any other components or may further reside as a separate entity.

The components discussed herein may provide a suitable website or other Internet-based graphical user interface which may be accessible by users. In one aspect, the Microsoft Internet Information Server (IIS), Microsoft Transaction Server (MIS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix Myself, Interpose, etc., may be used to provide an Active Data Object (ADO) compliant database management system.

Any of the communications, inputs, storage, databases or displays discussed herein may be facilitated through a website having web pages. The term “web page” as it may be used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML cascading style sheets (CSS), helper applications, plug-ins, and the like. A server may include a web service that receives a request from a web server, the request including a URL and an IP address. The web server retrieves the appropriate web pages and sends the data or applications for the web pages to the IP address. Web services are applications that are capable of interacting with other applications over a communications means, such as the internet Web services are typically based on standards or protocols such as XML, SOAP, WSDL and UDDI. Web services methods are well known in the art, and are covered in many standard texts. See, e.g., Alex Nehalem, IT Web Services: A Roadmap for the Enterprise (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of a software implementation, an entirely hardware implementation, or an implementation combining aspects of both software and hardware. Furthermore, the system may take the form of a computer program product on a computer-readable storage medium having computer-readable program code embodied in the storage medium. Any suitable computer-readable storage medium may be utilized, including hard disks, CD-ROM, optical storage devices, magnetic storage devices, and/or the like.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

In one aspect, the system and methods of the invention may be used to facilitate enjoyment of an amusement park venue. As will be apparent from the following description, various other aspects and applications of the systems and methods of the invention are possible. Although the invention may be described with relation to an amusement park venue, the operation of the system and methods are suitable for a variety of venues including museums; national attractions such as the Grand Canyon, Yellowstone Park, and Washington, D.C.; skiing mountains and other large recreational areas; convention halls and visitor bureaus; hotels; wholesale and retail markets; special events such as the Olympics or concerts; sporting events such as football, baseball, basketball, tennis, and any type of racing such as running, auto, and horse racing; and educational institutions. Therefore, the following example is not intended to limit the spirit or scope of the invention.

In general, the customer decides to visit a venue such as, for example, the amusement park. In one aspect, the customer may visit the amusement park's website, purchase and pay for admission, and reserve a PPOI device embodying certain aspects and for use within the invention. At the web site, the customer may also “preprogram” the PPOI device with various task lists of must-ride attractions, restaurants, or other points of interest that the customer desires to visit. At the end of the web site purchase process, the customer may be provided a confirmation number so the proper preprogrammed PPOI device may be obtained when they arrive. The invention may also allow a user's own PPOI device to be programmed through the Internet or at a certain programming station.

When customer arrives at venue, the customer picks up and pays for the PPOI device for use within venue 110. The PPM device may be rented or provided free with admission. If the customer previously used the website to pay for admission and reserve a device, the customer provides the confirmation number and a preprogrammed device may be provided. If a customer is with a group, multiple PPOI devices may be obtained and linked together via software or hardware, or one device can be obtained for the group designating the number of people in the group and possibly the group member's identities. The PPOI device may also be programmed with the customer's credit card number for any purchases to be made at the venue. Then, customer selects the appropriate language to display on the device.

As customer moves through venue 110, EIS 120 transmits positional information to the device. FSS 130 interprets this ever-changing information in order to provide data for specific features. Customers may activate the task list pre-programmed into the PPOI device to find the closest attraction with the least amount of wait time to the customer's current location. Through UIS 140, the PPOI device displays the list of attractions superimposed on a map of the amusement park. Wait times are located next to each of the attractions displayed on the map. Additionally, the shortest route may be indicated via a blinking line from the customer's current location. After viewing the options, the customer decides to walk to a particular attraction.

On the way to the attraction, the customer passes a refreshment stand. As EIS 120 provides the position information to FSS 130, FSS 130 triggers an advertisement for a refreshment product to be displayed on the PPOI device's screen along with a single beep to notify the customer of a message. Upon hearing and seeing the advertisement, the customer stops to purchase a refreshment.

In some aspects, the purchase may be done through the PPOI device. The customer may wave the device over a payment processing transceiver at the refreshment stand which transmits this information to FSS 130 and to a connected payment processing network. The purchase location information may also be recorded for later use.

Throughout the customer's trip, EIS 120 may be continually providing FSS 130 the customer's position. When the customer's position comes close to the intended attraction, FSS 130 transmits to a POI device, for example, a free-standing pole equipped with an LCD screen, at the entrance of the attraction (part of UIS 140), the name of the customer. The LCD displays a welcome message to the customer and the expected wait time. Additionally and/or alternatively, this information may be transmitted to the PPOI device. Furthermore, while the customer may be waiting in line, FSS 130 delivers background information about the attraction to the POI or PPOI devices. As shown in relation to FIG. 5A, venue information may include at least one of: history information, construction information, background information, sales information, pricing information, hours of operation information, author information, name information, distance information, loyalty program information, emergency information, sponsorship information, menu information, payment information, and status information.

Upon exit from the attraction, EIS 120 may supply the positional information to the FSS 130 which interprets the exiting movement of the device as the customer completing the attraction. As such, FSS 130 designates the attraction as completed and modifies the task list.

During the day, the customer visits other attractions and consults the PPOI device or other POI devices for additional information such as restroom location, shortest route to an eating establishment for lunch, times for viewing the next live attraction and the location of such attraction, and which attractions are left on the “must-see” task list.

Upon exit from venue 110, the PPOI device may be returned. In some aspects, the device may be accessed by the venue sponsor. Based on where the customer visited, whether that customer completed all the attractions, or other criteria, advertisements or coupons for future visits or sponsoring products may be distributed.

In another aspect, the systems and methods of the invention may be used to facilitate the experience of a wholesale market. For example, venue owners may preprogram devices embodying aspects of the invention with prices of goods at the market for a particular day. Buyers would be provided PPOI devices at the entrance of the market. As they roam through the market, EIS 120 tracks their location and provides this data to FSS 130. FSS 130 may provide features such as current pricing, suggested retail pricing, coupons, bulk discounts and the like. The type of information provided to buyers may be based on any number of factors such as identity of the buyer, previous purchases, and the like. Customers may purchase goods and services through the device and arrange for shipping of the items with or without the assistance of sales personnel. In other aspects, customers may pre-program a PPOI device via, for example, a website to create a “must-see’ task list. As the customer moves through the market, locations visited are checked off the list.

In another aspect, the systems and methods of the invention are used to facilitate the efficiency of a consumer's experience in a retail market such as a grocery store or warehouse store. For example, the consumer may select items available on the store's website. When the customer later goes to the store, a PPOI, which may be preprogrammed with the selected grocery list from the website, may be provided to the customer. FSS 130 may provide locations for the items, and suggest further items based on items in the list or where the customer has traveled within the store. Customer may pay for items using the PPOI device and arrange for shipping and/or bagging with or without the assistance of grocery store personnel.

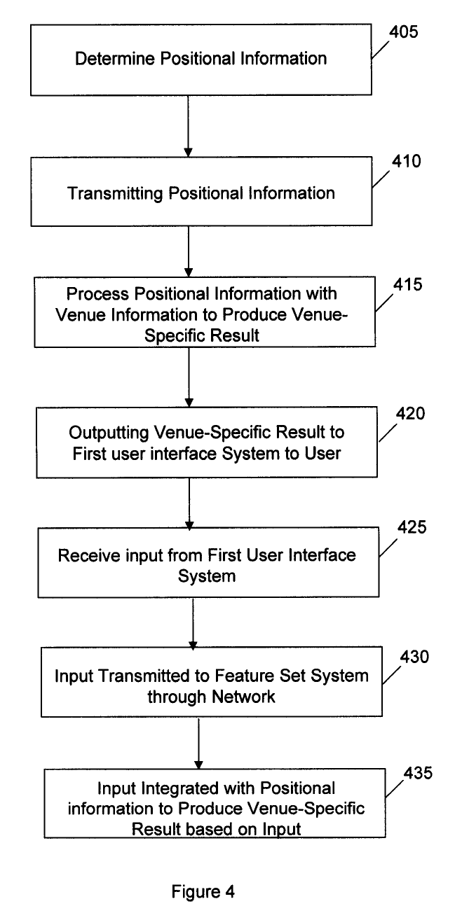

FIG. 4 is a flow diagram showing exemplary steps of the invention. FIG. 4 may also represent a block diagram of the components for performing the corresponding steps thereof, which may include a storage medium readable by a machine containing a set of program instructions when executed by the machine performs the corresponding steps. At step 405, positional information related to an item in a venue via an environment interface system may be determined. This may be done via an environment interface system. At step 410, the positional information may be transmitted through a network, which may include transmitting the positional information to a feature set system. At step 415, the positional information may be processed with venue information in order to produce a venue-specific result. At step 420, the venue-specific result may be outputted through the network to a first user interface system. At step 425, input from the first user interface system may be received. At step 430, the input may be transmitted to the feature set system through the network. At step 435, the input may be integrated with the positional information to produce a venue-specific result based on the input.

In another aspect, communications from operational management at a venue, such as a theme park, state fairs, festivals, convention, and the like, to the patrons could improve overall satisfaction for both parties by increasing satisfaction for the patrons while improving efficiencies and revenues for the venue operations. An exemplary description for a system and method for facilitating transactional, positional and user interactive features at a venue through communications devices is described in U.S. patent application Ser. No. 11/227,311, filed Mar. 23, 2006, entitled “USER POSITIONAL AND VENUE INFORMATION INTEGRATION SYSTEM AND METHOD,” which is incorporated by reference herein, and a portion of which is attached hereto as part of this application in an appendix, forming a part of this application. Such a system and method, as described in U.S. patent application Ser. No. 11/227,311, forms an exemplary basis for expanded features to provide an enhanced system and enhanced methods as described herein. The enhanced system and methods described herein include providing:
Advice to the patrons at a venue, through a time based “pop-up,” on a patron's communications device (e.g., a personal digital assistant, Blackberry®, cell phone, and the like) configured to communicate with the venue's operational management control system (e.g., one or more components of venue informational system 100 of U.S. patent application Ser. No. 11/227,311) that interacts with the patron's device that a show is scheduled in 40 minutes (for example), and a prompt may be presented to the patron inquiring if they would like navigation assistance to the show. If a positive response to the prompt is received, the system provides navigation to the show, perhaps based on the time of the show and/or based on other possible attractions that may be visited in a timely fashion while enroute to the show. A route, perhaps from among a plurality of routes, may be evaluated based on show time and remaining time available and possibly based on appropriate attractions available in one or more possible routes. In this way, a patron might “squeeze-in” another attraction(s) while migrating towards the show for timely arrival. In some aspects, the possible alternate routes with possible alternate intervening attractions may be presented to the patron for selection. The alternate attractions may also be weighted for viable inclusion in the route selection based upon their own wait times.
The venue (e.g., venue's operational management control system) may provide audio/video and/or text information related to the show that is being presented as an option for increasing information for the patron in which to make a decision. This information may reside on the user receiver(s) (e.g., patron's communication's device) or be transmitted by the venue operational management system as streaming video or similar formats.
Updates to patrons as to the availability of seating and/or other show related information (such as queue length to acquire tickets) as one or more show times get closer. For example, with 20 minutes prior to the show, an announcement from the venue's operational management control system to the patron's communication's device might include “The show is now 75% full and we anticipate that it may be full in the next 5 minutes. If you are not within 5 minutes of the show we have the following entertainment alternatives available to you.” A new set of alternatives may be displayed to the patron for consideration and perhaps resetting a new agenda for touring the venue.
Advise patrons when seating for a specific show is closed. For example, an advisory to the patron(s) may state: “The 3 pm show is now full. We would suggest that you consider attending the following entertainment options now available to you.” Followed by a new list of alternative shows or events, etc.

The enhanced system and methods of the invention include providing communications from the patrons to the venue operations management system or to the user device (such as a FUNFinder, Inc. user device) which allows the patrons to accomplish any of the following:
Patrons may communicate with the venue's operational management system that they would like to attend a show (or event/attraction) being offered (on the patron's device) and be sent a picture or rendering of a ticket that may be used for admission. This allows the venue operational management system to set aside a number of seats for the patrons, perhaps prime seats, if options permit. The electronic ticket may be presented at the time of entry to the show. The ticket acquisition procedure may be used for individual patrons or groups of patrons. As reservations are made the reservations may be automatically tabulated on the venue's server (or other controller) to ensure that the event is not overbooked. If capacity is reached for a show/event the server may simply be programmed to stop allowing reservations, and optionally provide the patron an appropriate response, perhaps alternative show times, or other attractions.
If the show selected by a patron requires a payment to attend, the patron's communications device (such as the FUNfinder, Inc. user device) may facilitate the transaction. The patron's communication device may be rented at the venue and a patron's credit card (or other payment arrangement such as debit card or billing to a hotel room, for example) may be processed to ensure that the rented patron's user device is likely to be returned. The credit card used by the patron may also be electronically linked with the specific patron device that has a unique address, such as an RFID address. When the patron requests seating at a show, the venue operational management system may query the patron via the communication device whether or not the patron would like to use the credit card (or other payment arrangement) previously provided. If the patron agrees, the transaction may be processed and a .jpg (or similar image) of a ticket can be sent to the communication device which can then be scanned (or otherwise presented) at the show entrance. An electronic receipt may also be provided.

The patron(s) communication device, which may be a hand held mobile device, may comprise a GPS unit as described in U.S. patent application Ser. No. 11/227,311 which may be integrated with GSM, CDMA, WiFi or Wmax capability. The navigation aspect herein may be accomplished through the venue-specific GPS features, also described in U.S. patent application Ser. No. 11/227,311, for example. Communications with the patron's device(s) or receivers may be facilitated through a venue operations center, for example also as described in U.S. patent application Ser. No. 11/227,311. A data link through this type of center allows for transmission of information from the venue operations management system to patrons' communications devices, such as via FUNfinder, Inc. receivers, or from the FUNfinder receiver to the venue operations management system through GSM, CDMA, WiFi or Wmax, for example.

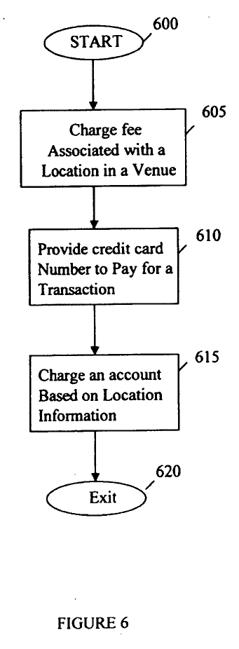

FIG. 6 is a flow diagram showing various aspects of the invention, starting at step 600. FIG. 6 may also represent a block diagram of the components for performing the steps thereof. At step 605, venue-specific results may include charging a fee associated with a location in the venue. At step 610, an item may be configured to provide a credit card number to pay for a transaction in the venue. At step 615, the feature set system may charge an account based on said location information. At step 620, the flow ends.

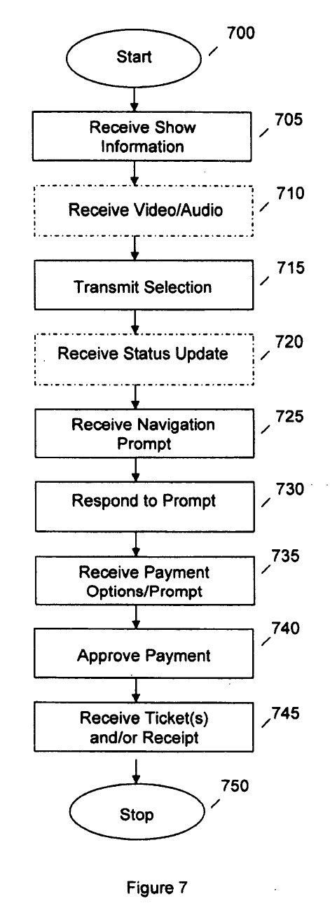

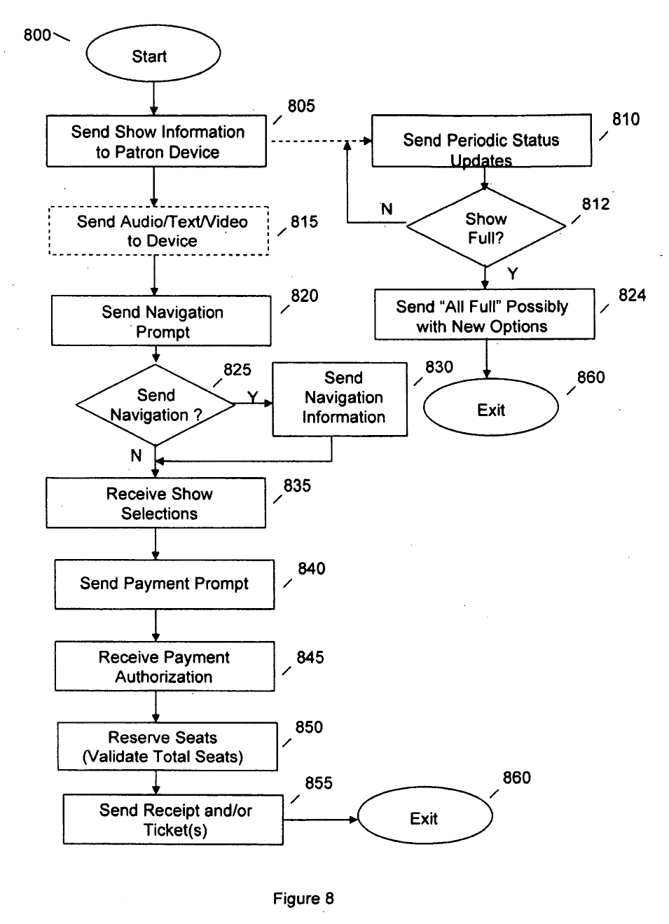

FIG. 7 is a flow diagram showing steps of an exemplary process performed according to principles of the invention, starting at step 700. The flow diagram of FIGS. 7 and 8, and all other flow diagrams herein, may also be a block diagram of the components for performing the steps thereof, including, but not limited to, for example, hardware, software or any combinations thereof. The components may be executed on an appropriate computer medium, including, for example, a computer processing platform, an electronic circuit, and/or stored in a computer readable memory or storage device such as a hard drive, a flash drive, a ROM, a RAM, a CD, a DVD, or the like.

At step 705, a patron may receive show, event, or attraction information from a venue operations management system on the patron device in communication with the venue operations management system. Such information may include any one or more of scheduled performance, availability times, seating availability (perhaps per show), seating costs, seating charts, restrictions such as age limitations or size limitations, promotional information (e.g., coupons or discounts or available teaser gifts and the like), payment options, and the like. The information and show/event information may be based on geographic location of the patron within the venue (e.g., the closest attraction of interest to the patron might be displayed). The location of the patron may be ascertained by a location determination technique such as GPS, for example, and conveyed to the venue operations management system. At optional step 710, the patron device may receive audio, visual or graphical information to increase information flow to the patron. Such information may include a snippet video of the attraction, show, or event, seating arrangements, route mapping to get to the attraction, show, or event, or associated audio or graphics to better convey the show, attraction or event, convey visual or audio options to the user, or the like.

At step 715, the user may make a selection based on the received information and the patron device may transmit a resulting selection. The selection may include purchase of one or more tickets, for example. At step 720, the patron may receive periodic status updates on the patron device from the venue operations management system such as changes in seating availability or time to showing, time to travel to the show location (based on GPS information perhaps), and the like. At step, 725, a navigation prompt may be received at the patron device prompting whether or not navigation information may be desired by the patron to migrate towards the show, event, or attraction location. At step 730, the patron may respond to the prompt to either indicate a desire to receive navigation information, or not. Navigation information may include textual instructions or a graphical type display showing routes, for example.

At step 735, the patron may receive a prompt on the patron device asking for payment. The prompt may include options for paying for the tickets, such as by credit card, or by a pre-arranged payment agreement, which may include a cash type deposit, a credit card or debit card number on record. At step 740, the patron may approve the payment, perhaps by secure transaction authorization. At step 745, the patron may receive an electronic ticket(s) and/or receipt. Alternatively, the receipt may indicate that a ticket(s) is available at a “Will-Call” booth, for example. At step 750, the process stops.

FIG. 8 is a flow diagram of an exemplary process performed according to principles of the invention, starting at step 800. At step 805, show (or event, or attraction) information may be sent to a patron's communication device, perhaps as a response to an inquiry by the patron.

At step 810, a parallel function (denoted by the dotted arrow connecting step 805 and step 810) may periodically send updates to the patron's communications device to provide “real-time” status updates such as current remaining seats available, time to show, postponement information, or the like. This information may keep the patron updated with changes or new information associated with the show. At step 812, a check may be made whether or not the seating for the show has reached full capacity. If not, processing may continue at step 810. However, if the show is now deemed full, then at step 824, a notice may be sent to the patron's communication device indicating a “full show.” Alternative options may also be sent to the patron such as other show times to other shows or attractions, perhaps a new itinerary may also be proposed to the patron based on location of the patron (known by GPS, for example).

Also from step 805, the process may continue at optional step 815 (in parallel with steps 810, 812, and 824) by sending audio/video/graphical/textual (in any combination) to the patron's device that may enhance the awareness of the patron such as an audio or video clip describing show content, layout of seating, restrictions, costs, payment options, and the like.

At step 820, a navigation prompt may be sent to the patron asking if navigation information may be desired, such as to help direct the patron to the show location. At step 825, a check may be made to determine whether or not the patron desires navigation information. If desired, at step 830 navigation information may be sent to the patron's communications device, perhaps in text, video, audio graphic or any combination thereof. Periodic updates to this navigation information may also be sent as the patron's location changes within the venue. The process may continue at step 835.

At step 835, a patron's selection of a show may be received, likely with an indication to purchase or reserve tickets. At step 840, if the selection warrants a purchase transaction, a payment prompt may be sent to the patron's communication device. At step 845, authorization may be received to complete the payment transaction, which may include billing information such as a credit card or debit card number, or authorization to charge against a pre-established account (such as a hotel room, for example). At step 850, appropriate reservations may be accounted for by the venue management system, such as reserving an appropriate number of seats. Also, a check may be made to verify that a total number of available seats have not been exceeded. (Note: alternatively, this check for available seats may be performed by a previous step such as at step 835 for example). If a total number of seats have been exceeded, the transaction may be aborted, and appropriate alternative action may be initiated such as offering other choices. At step 855, an electronic ticket(s) (or equivalent electronic indicator) and/or receipt may be sent to the patron's device for use in gaining entrance to the show. At step 860, the process may exit.

It should be understood that various principles of the invention have been described in illustrative examples. However, many combinations and modifications of the above-described components, used in the practice of the invention, in addition to those not specifically described, may be varied and particularly adapted to specific environments and operating requirements without departing from those principles. Other variations and modifications of the present invention will be apparent to those of ordinary skill in the art, and it is the intent that such variations and modifications be covered.

What is claimed is:

1. A method for managing attendance at a venue, the venue having a plurality of different attractions managed at least in part by a computerized operational venue management system, the method comprising:
receiving at a mobile communications device from the computerized operational venue management system information related to at least one attraction within the venue, the mobile device associated with a patron of the venue, the venue having pre-defined boundaries;
responding to the information to indicate a intent to purchase at least one entrance pass to at least one attraction; and
receiving a receipt at the mobile communications device.

2. The method of claim 1, wherein the step of receiving includes receiving an electronic ticket to the at least one attraction.

3. The method of claim 1, further comprising receiving navigation information from the computerized operational venue management system to aid a patron in locating the at least one of the attractions within the venue.

4. The method of claim 1, further comprising receiving at least one of audio, video, and graphics related to the at least one attraction to aid in explaining the at least one attraction.

5. The method of claim 1, wherein the step of responding includes authorizing payment for the at least one entrance pass.

6. The method of claim 1, wherein the step of receiving a receipt includes receiving at least one pass to at least one attraction.

7. The method of claim 1, further comprising the step of authorizing payment for the at least one entrance pass.

8. The method of claim 1, further comprising the step of receiving periodic updates on a status of the at least one attraction.

9. The method of claim 8, wherein the status includes information related to available seating.

10. A system for managing attendance at a venue, the venue having a plurality of different attractions, the system comprising:
an operational venue management system that manages at least in part the plurality of different attractions, the operational venue management system comprising:
a first component to transmit information related to at least one attraction within the venue to at least one mobile communications device associated with a patron of the venue, the venue having pre-defined boundaries;
a second component to receive information that indicates an intent to purchase at least one entrance pass to at least one attraction; and
a third component to communicate a receipt to the mobile communications device.

11. The system of claim 10, wherein the receipt comprises an electronic ticket to the at least one attraction.

12. The system of claim 10, further comprising a fourth component to transmit navigation information to aid a patron in locating the at least one of the attractions.

13. The system of claim 10, wherein the first component transmits at least one of audio, video, and graphics related to the at least one attraction to aid in explaining the at least one attraction to a patron.

14. The system of claim 10, wherein the second component receives authorization for a payment for the at least one entrance pass.

15. The system of claim 10, wherein the third component transmits at least one pass to the at least one attraction.

16. The system of claim 10, further comprising an update component configured to periodically send an update to the at least one mobile communications device related to a status of the at least one attraction.

17. The system of claim 16, wherein the status includes information related to available seating.

18. The system of claim 10, further comprising a location tracking component to track the location of the at least one mobile communications device within the venue.

19. A system for managing attendance at a venue, the venue having a plurality of different attractions, the system comprising:
an operational venue management system that manages at least in part the plurality of different attractions, the operational venue management system comprising:
a first component to transmit information related to at least one attraction within the venue to at least one mobile communications device configured to be carried by a patron of the venue, the venue having pre-defined boundaries maintained in a database readable by the operational venue management system;
a second component to receive information that indicates an intent to make a purchase associated with at least one attraction pre-defined as part of the venue; and
a third component to communicate a receipt to the mobile communications device.
